(19) United States
(12) Patent Application Publication
(10) Pub. No.: US 2024/0328814 A1
(43) Pub. Date: Oct. 3, 2024

(54) NON-FIXED PARKING SPACE INFORMATION NAVIGATION SYSTEM

(71) Applicant: OmniEyes Co., Ltd. Taiwan Branch, Taipei City (TW)

(72) Inventors: Chung-Sheng LAI, Taipei City (TW); Chung-Yuan CHEN, Taipei City (TW); Chun-Ting CHOU, Taipei City (TW)

(21) Appl. No.: 18/129,492

(22) Filed: Mar. 31, 2023

(51) Int. Cl. G01C 21/36; G01C 21/00

(52) U.S. Cl. CPC G01C 21/3685; G01C 21/3602; G01C 21/3889

(57) ABSTRACT

The present invention provides a smart parking function, a vehicle camera and a sensor to obtain driving information, artificial intelligence analysis (AI), and a logistics vehicle system. The present invention provides a non-fixed parking space information navigation system, which includes: a front-end device, which is used to install on a vehicle, for a user to input demand; an edge computer, which includes a sensor and a camera, can be installed on the vehicle; a display device, which is installed on the vehicle, to display a positioning data or a parking data; a database, which is used to store the video shot by the camera and record the positioning data of the vehicle or the parking data; a server, which is used to connect the database and the display device, and transmit the video to the display device, and store the record in the database; an artificial intelligence system, which is connected to the database and server, and can analyze the status of the vehicle through the video, positioning data and parking data.

### FIELD OF THE INVENTION

The present invention provides an image capture module and sensor including intelligent parking function, vehicle to obtain driving information, perform artificial intelligence analysis, and be applied to a logistics vehicle system.

### BACKGROUND OF THE INVENTION

A courier or delivery service is a service that picks up goods from a specific location and transports them to another location. For every courier or delivery service, the courier will be given two addresses: one is where the goods are picked up and the other is where the goods are delivered. Whether it is the pickup address or delivery address, the courier needs to park the vehicle in a better parking space near the target address, then get off and walk to the address. Therefore, finding an effective parking space is an important skill for a courier and an important part of the service process. If couriers can find empty parking spaces quickly, there will be fewer detours, saving fuel and time for courier companies. However, when a novice courier or courier is sent to a new area for the first time, it takes time to get familiar with the environment and find a better parking space. During this learning period, the delivery service will consume more fuel and time, which increases the cost for the company.

In the express-to-vehicle delivery method, when the logistics end receives the express-to-vehicle delivery task, how to allocate the express delivery warehouse and how the courier accurately locates the vehicle so that the logistics end finds the target vehicle in the shortest time are the difficulties. In the past, when the database was established, the judgment of the parking spot was often inaccurate, so it led to the wrong position.

### SUMMARY OF THE INVENTION

In view of this, the present invention proposes a non-fixed parking space information navigation system with an artificial intelligence system to overcome the inaccurate judgment of the parking spot of the car. where to park and advise novice couriers to park at these locations to save time and fuel.

The present invention provides a smart parking point suggestion function (Smart Parking), an image capture module (Camera)/sensor of the vehicle 2 to obtain driving information, artificial intelligence analysis (AI), and applied to the logistics vehicle 2 system (Logistics). The non-fixed parking space information navigation system provided by the present invention includes: a front-end device, which is used to install on a vehicle 2, for a user to input requirements; an edge computer, which includes a sensor and an image capture module, which can be installed on the vehicle 2; a display device 3, which is installed on the vehicle 2, to display a positioning data or a parking data; a database, which is used to store the images captured by the image capture module image, and record the positioning data or the parking data of the vehicle 2; a server 1, which is used to connect the edge computer, the database and the display device 3, and transmit the image to the display device 3, and The record is stored in the database; an artificial intelligence system is connected to the database and the server 1, and can analyze the state of the vehicle 2 through the image, positioning data and parking data.

Preferably, the parking data of the present invention includes at least one of a real-time satellite positioning data, a real-time gyroscope positioning data, a real-time three-dimensional map data and the parking position data input by the user.

Preferably, the edge computer includes, but not limited to, a driving recorder, a fleet management on-board computer, or a mobile device installed on the vehicle.

Preferably, the database of the present invention can be an associative or non-associated database with a geospatial query function. It can be, but not limited to, a database built on a local network, or a database deployed on the cloud.

Preferably, the server 1 of the present invention can be a local computer or a computer system deployed on the cloud, to provide the edge computer to transmit data to the database, query the database at the request of the front-end device, and perform calculations based on the query results of the database method analysis, and transfer data to front-end device and other functions, but not limited thereto. Preferably, the front-end device of the present invention can be, but not limited to, a customized device or a mobile device including button input, touch input, voice interaction, and barcode scanning functions, to provide the deliveryman with convenient data input and output.

The present invention also provides a method of using the non-fixed parking space information navigation system of the vehicle 2, which is through the non-fixed parking space information navigation system of claim 1, including: (a) the user installs the front-end device and the sensor on the vehicle; (b) the user inputs a demand through the front-end device after the vehicle travels; (c) the database displays the positioning data or parking data through the display device; and (d) the user parks according to the positioning data or parking data.

Preferably, the artificial intelligence system of the present invention can judge the parking state of the previous vehicle 2 according to the GPS of the previous vehicle 2 and the corresponding image in the offline non-real-time calculation stage, to estimate whether the location is suitable as a suggested parking space. Preferably, in the real-time computing stage, the user can search the location data or parking data of the former user through the front-end device and obtain a parking space.

Preferably, the artificial intelligence system of the present invention uses a recognition model to detect the state of the vehicle, and judges the user's vehicle based on the position of the adjacent vehicle visible in the image; if other vehicles are in the same position on the screen within a period of time, it means that the user's vehicle and the adjacent vehicle have no relative movement within the time period, and it is judged that the user's vehicle is parked on the road or at a red light; if the adjacent vehicles visible on the screen do not have the same vehicle at the same position within a period of time, it is judged that the user's vehicle has left the traffic flow and should be parked on the side of the road.

Preferably, the artificial intelligence system of the present invention uses a recognition model to detect the state of the vehicle 2, the artificial intelligence system can judge the state of the vehicle 2 according to the positioning data of the vehicle and the image of the server, and judge whether the vehicle is stopped at a red light or parked on the roadside or the parking status of the parking space.

Preferably, the present invention can match possible delivery locations according to the delivery address; if the match is successful, the delivery address and the parking spot are stored together in the database.

Preferably, the present invention further includes a feedback system for the user to provide feedback on the suggested parking space, to improve the parking state judgment ability of the artificial intelligence system, or to improve the parking point recommendation algorithm.

The purpose of the present invention is to collect the parking spaces selected by experienced couriers and users into the database, so that new couriers or users can obtain the best parking spaces in the most efficient way through the system of the present invention, which can reduce delivery time and fuel, and at the same time familiarize yourself with the areas in an efficient manner. Not only that, but the feedback system of the present invention can also update the artificial intelligence system and database, and the next courier or user can choose a parking space more efficiently. For example, the user can give positive feedback to the appropriate recommended parking spot on the front-end device, otherwise, unreasonable recommended parking spots will be given negative feedback, and the feedback data will be transmitted to server 1 through the front-end device to record the feedback information in the database, which will be used for the artificial intelligence system's parking status judgment ability and the parking spot recommendation algorithm is improved.

### BRIEF DESCRIPTION OF THE DRAWINGS

FIG. 1 is a description of the system architecture and the parking point judgment algorithm of the present invention.

FIG. 2 is a schematic diagram of the method of using the non-fixed parking space information navigation system of the vehicle of the present invention.

### DETAILED DESCRIPTION OF THE INVENTION

The foregoing general description and the following detailed description are exemplary and explanatory and are not intended to limit the scope of the patent application for the present invention. Certain details of one or more embodiments of the invention are aggregation forth in the description below. Other characteristics or advantages of the present invention will be apparent from the following non-exhaustive list of representative embodiments, also from the appended claims.

Certain terms are used in the specification and subsequent claims to refer to elements. It should be understood by those skilled in the art that hardware manufacturers may use different terms to refer to the same component. This description and subsequent patent applications do not use the difference in name to distinguish components but use the difference in function of components as a criterion for distinguishing. The “comprising” mentioned in the entire specification and the subsequent claims is an open term, so it should be interpreted as “including but not limited to”. Otherwise, the word “connect” here includes any direct and indirect means of electrical connection. Therefore, if it is described that a first device is connected to a second device, it means that the first device may be directly electrically connected to the second device, or indirectly electrically connected to the second device through other devices or connection means.

The present invention collects images from the image capture module of the vehicle 2 and sensor data from the on-board unit and provides them to a deep learning model in artificial intelligence to determine whether the vehicle 2 is parking for delivery. The status of the vehicle 2 can be suspended at a red light or parked on the roadside to deliver goods. Second, each time the courier stops at a location, the system of the present invention will match the location with a candidate address suggested in the system, which can be the source address of departure, or the destination address of delivery. The invention can record all parking locations and suggested addresses and use this matching information in subsequent tasks. In addition, according to the collected data, the system of the present invention can suggest several parking locations for the user to choose when receiving the input address and display the results on the front-end device.

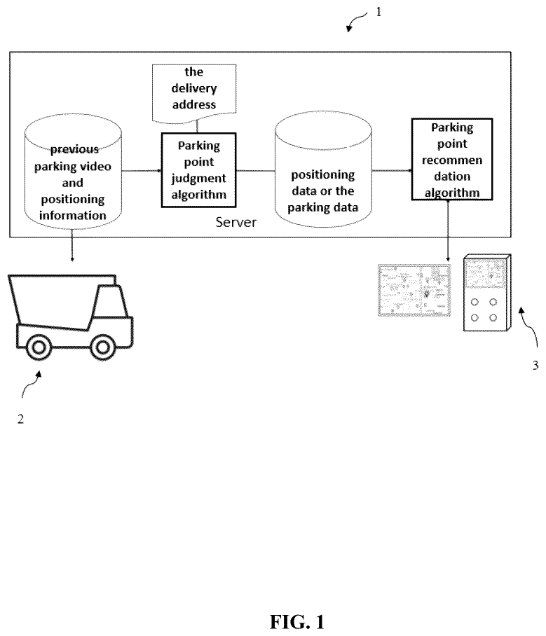

As shown in FIG. 1, the present invention provides a smart parking function (Smart Parking), an image capture module (Camera)/sensor (Sensor) of the vehicle 2 to obtain driving information, artificial intelligence analysis (AI), and applied to Logistics vehicle 2 system (Logistics). The non-fixed parking space information navigation system of the present invention includes: a front-end device installed on a vehicle 2 for a user to input requirements; an edge computer including a sensor and an image capture module, which can be installed on the vehicle 2; a display device 3, which is installed on the vehicle 2, to display a positioning data or a parking data; a database, which is used to store the previous image captured by the image capture module image, and record the positioning data or the parking data of the vehicle 2; a server 1, which is used to connect the database and the display device 3, and transmit the image to the display device 3, and store the record in In the database, the server 1 further includes a parking point judgment algorithm, through which the previous parking video and positioning information in the database are accessed to determine where the previous parking point is; the server 1 further includes a parking point recommendation algorithm, through the parking point recommendation algorithm, responds to the request of the front-end device, accesses the previous parking points in the database, and returns the recommended parking points to the display device 3 and the front-end device after being sorted by the algorithm; an artificial intelligence system is connected to the database and server 1, and can analyze the status of the vehicle 2 through the image, positioning data and parking data.

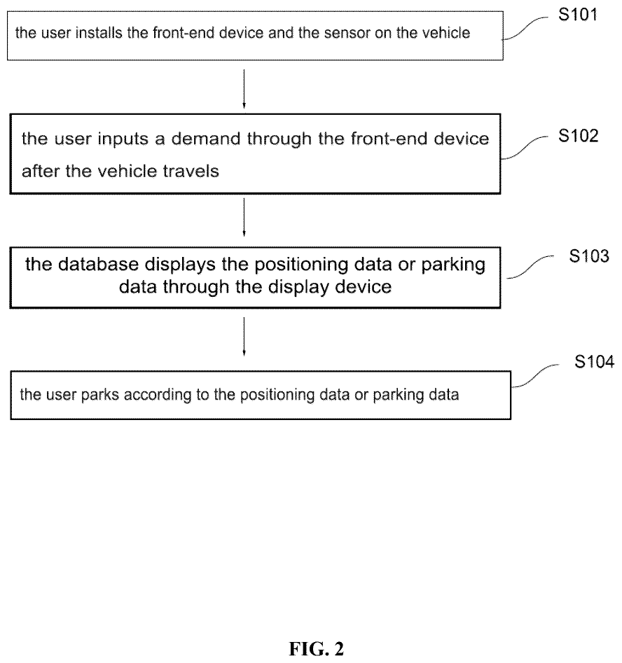

FIG. 2 is a schematic diagram of the method of using the non-fixed parking space information navigation system of the vehicle 2 of the present invention. Some edge computers with sensors and image capture modules will be installed on delivery vehicles 2 that deliver goods every day. The data collected by the sensor and the image captured by the image capture module will be sent to server 1 and stored in the database. The new courier will get a front-end device, which can query server 1 for parking space suggestions, and display the above information on display device 3 as a screen.

The system of the present invention can judge whether vehicle 2 is in roadside parking or temporary parking state, because there are several situations that vehicle 2 may stop on the road, such as waiting for a red light to pause, or waiting for other vehicles 2 to pass and pause on the road. In this part, the artificial intelligence system of the present invention not only utilizes the images taken by the vehicle 2, GPS information and ignition status of the vehicle 2, but also uses deep learning detection models, classification models and rule-based algorithms to determine whether the vehicle 2 is parked. After the present invention calculates and confirms that the vehicle 2 is parked, the parking location is bound to one of the candidate addresses. These addresses are the source address or target address of one-day delivery. The system further obtains data on delivery of goods from some customers. Various rules can be used to determine if a parking location is suitable for a particular address, and then the GPS of the specific address is used as an input value, and the corresponding parking location is used as its value, indicating that a courier has parked at that location at that address. Finally, the system of the present invention is configured with a front-end display device 3, and the courier can input the address to be visited in the system of the present invention, and the system of the present invention will return several parking spaces for the courier to choose according to the parking spot recommendation algorithm. Then, the courier can provide feedback on the parking experience through the feedback system of the present invention, and then the system can be modified according to the feedback to continuously evolve.

The above descriptions are only preferred embodiments of the present invention, and all equivalent changes and modifications made according to the scope of the patent application of the present invention shall fall within the scope of the present invention.

What is claimed is:

1. A non-fixed parking space information navigation system, which includes:
a front-end device, which is used to be installed on a vehicle for a user to input requirements;
an edge computer, which includes a sensor and an image capture module, can be installed on the vehicle;
a display device installed on the vehicle for displaying a positioning data or a parking data;
a database, which is used to store an image captured by the image capture module, and record the positioning data or the parking data of the vehicle;
a server, which is used to connect the database and the display device, transmit the image to the display device, and store the record in the database; and
an artificial intelligence system, which is connected to the database and the server, and can analyze the state of the vehicle through the image, the positioning data and the parking data.

2. The non-fixed parking space information navigation system of claim 1, the artificial intelligence system can judge the state of the vehicle according to the positioning data of the vehicle and the image of the server, and judge whether the vehicle is stopped at a red light or parked on the roadside or the parking status of the parking space.

3. The non-fixed parking space information navigation system of claim 1, the parking data includes at least one of a real-time satellite positioning data, a real-time gyroscope positioning data, a real-time three-dimensional map data and the parking position data input by the user.

4. The non-fixed parking space information navigation system of claim 1, the artificial intelligence system uses a recognition model to detect the state of the vehicle, and judges the user's vehicle based on the position of the adjacent vehicle visible in the image; if other vehicles are in the same position on the screen within a period of time, it means that the user's vehicle and the adjacent vehicle have no relative movement within the time period, and it is judged that the user's vehicle is parked on the road or at a red light; if the adjacent vehicles visible on the screen do not have the same vehicle at the same position within a period of time, it is judged that the user's vehicle has left the traffic flow and should be parked on the side of the road.

5. The non-fixed parking space information navigation system of claim 4, the recognition model further detects the state of the vehicle according to an immovable parking sign around the user's vehicle; if the parking sign is a red light, it is judged that the user's vehicle is parked at a red light; if the stop sign has no red light, it is judged that the user's vehicle has left the traffic flow and should be parked on the side of the road.

6. The non-fixed parking space information navigation system of claim 1, the server includes a parking point judgment algorithm, which accesses the previous parking image and positioning information in the database, and judges which is the previous parking point, and try to match with the delivery address, if the match is successful, store the delivery address and the parking spot together in the database.

7. The non-fixed parking space information navigation system of claim 1, the server includes a parking spot recommendation algorithm, and the previous parking spot in the database is accessed through the parking spot recommendation algorithm in response to the request of the front-end device; after being screened and sorted by the algorithm, the recommended parking spots are provided to the display device and/or the front-end device.

8. The non-fixed parking space information navigation system of claim 1, the system further includes a feedback system that provides the user with feedback on the suggested parking space, so as to improve the parking state judgment ability of the artificial intelligence system, or for the parking spot recommendation algorithm to improve.

9. The non-fixed parking space information navigation system of claim 1, the edge computer includes a driving recorder, a fleet management on-board computer, or a mobile device installed on the vehicle.

10. The non-fixed parking space information navigation system of claim 1, the database is a relational or non-relational database with geospatial query function.

11. The non-fixed parking space information navigation system of claim 1, the server is a computer device or a cloud computer system, which provides the edge computer to transmit data to the database, queries the database according to the request of the front-end device, performs algorithm analysis according to the query results of the database, and then calculates Analysis results are transferred to the front-end device.

12. The non-fixed parking space information navigation system of claim 1, the front-end device is a mobile device with an input function for the deliveryman to input and output data.

13. A method of using the non-fixed parking space information navigation system of a vehicle, which is through the non-fixed parking space information navigation system of claim 1, including:
(a) the user installs the front-end device and the sensor on the vehicle;
(b) the user inputs a demand through the front-end device after the vehicle travels;
(c) the database displays the positioning data or parking data through the display device; and
(d) the user parks according to the positioning data or parking data.

14. The method of using the non-fixed parking space information navigation system of claim 13, the user can search the location data or parking data of the former user through the front-end device, and obtain a parking space.

15. The method of using the non-fixed parking space information navigation system of claim 13, the artificial intelligence system can judge the status of the vehicle according to the image input by the vehicle's GPS and server.

16. The method of using the non-fixed parking space information navigation system of claim 13, the artificial intelligence system uses a recognition model to detect the state of the vehicle, and judges the user's vehicle based on the position of the adjacent vehicle visible in the image; if other vehicles are in the same position on the screen within a period of time, it means that the user's vehicle and the adjacent vehicle have no relative movement within the time period, and it is judged that the user's vehicle is parked on the road or at a red light; if the adjacent vehicles visible on the screen do not have the same vehicle at the same position within a period of time, it is judged that the user's vehicle has left the traffic flow and should be parked on the side of the road.

17. The method of using the non-fixed parking space information navigation system of claim 13, the artificial intelligence system can judge the state of the vehicle according to the positioning data of the vehicle and the image of the server, and judge whether the vehicle is stopped at a red light or parked on the roadside or the parking status of the parking space.

18. The method of using the non-fixed parking space information navigation system of claim 17, the server includes a parking point judgment algorithm, which accesses the previous parking image and positioning information in the database, and judges which is the previous parking point, and try to match with the delivery address, if the match is successful, store the delivery address and the parking spot together in the database.

19. The method of using the non-fixed parking space information navigation system of claim 18, the system further includes a feedback system that provides the user with feedback on the suggested parking space, so as to improve the parking state judgment ability of the artificial intelligence system, or for the parking spot recommendation algorithm to improve.
